(19) United States
(12) Patent Application Publication
(10) Pub. No.: US 2016/0218592 A1
(43) Pub. Date: Jul. 28, 2016

(54) ELECTRIC GENERATOR

(71) Applicant: Kuo-Chang HUANG, Tainan City (TW)

(72) Inventor: Kuo-Chang HUANG, Tainan City (TW)

(21) Appl. No.: 14/996,272

(22) Filed: Jan. 15, 2016

(30) Foreign Application Priority Data
Jan. 23, 2015 (TW) 104102349

(51) Int. Cl. H02K 7/18; H02K 1/27

(52) U.S. Cl. CPC H02K 7/1823; H02K 1/2786

(57) ABSTRACT

An electric generator includes a base unit, a driving unit and at least one power generating unit. The base unit includes a shaft. The driving unit includes a tubular member that surrounds the shaft and that is rotatable about the shaft, and a plurality of blade modules that are disposed co-rotatably on the tubular member. The power generating unit includes a stator that is connected fixedly to the shaft, and a rotor that is connected co-rotatably to the tubular member. The rotor is rotated relative to the stator to induce a current when the blade modules are driven by a fluid flow to rotate the tubular member relative to the shaft.

### CROSS-REFERENCE TO RELATED APPLICATION

This application claims priority of Taiwanese Application No. 104102349, filed on Jan. 23, 2015.

### FIELD

The disclosure relates to an electric generator, and more particularly to a fluid power generator.

### BACKGROUND

Referring to FIGS. 1 and 2, a conventional horizontal-axis wind turbine includes a tower 9, a housing 8, a driving unit 7 and a power generating unit 6. The housing 8 is disposed on a top portion of the tower 9, and defines a power generating space 81 therein. The driving unit 7 includes a horizontal rotating shaft 71 that extends rotatably into the power-generating space 81, and three blades 72 that are mounted co-rotatably to a front portion of the rotating shaft 71. The power generating unit 6 includes a stator 61 that is mounted fixedly in the power generating space 81, and a rotor 62 that is mounted co-rotatably to the rotating shaft 71. When the blades 72 are propelled by wind to rotate the rotating shaft 71, the rotor 62 is rotated relative to the stator 61 so as to induce a current.

Compared with the whole length of the conventional horizontal-axis wind turbine in the longitudinal direction of the rotating shaft 71, the housing 8 has a relatively small size, so that the power-generating space 81 is relatively small. As a result, the number of turns of coils of the power generating unit 6 is limited by the size of power-generating space 81, and the current induced by the power generating unit 6 is relatively small.

Moreover, due to the configuration of the conventional horizontal-axis wind turbine, the blades 72 can only be mounted to a relatively small portion of the rotating shaft 71 (i.e., the front portion), so that the driving unit 7 has relatively inferior structural strength.

### SUMMARY

Therefore, an object of the disclosure is to provide an electric generator that can overcome at least one of the aforesaid drawbacks associated with the prior art.

According to the disclosure, the electric generator includes a base unit, a driving unit and at least one power generating unit. The base unit includes a shaft. The driving unit includes a tubular member that surrounds the shaft and that is rotatable about the shaft, and a plurality of blade modules that are disposed co-rotatably on the tubular member. The power generating unit includes a stator that is connected fixedly to the shaft, and a rotor that is connected co-rotatably to the tubular member. The rotor is rotated relative to the stator to induce a current when the blade modules are driven by a fluid flow to rotate the tubular member relative to the shaft.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a conventional horizontal-axis wind turbine;

FIG. 2 is a sectional view of the conventional horizontal-axis wind turbine;

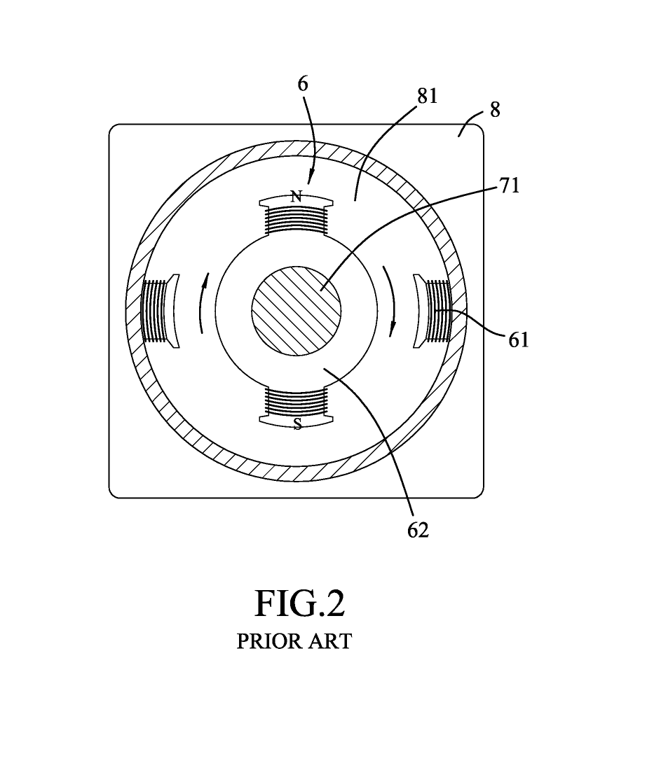

FIG. 3 is a perspective view of a first embodiment of the electric generator according to the disclosure;

FIG. 4 is a fragmentary exploded perspective view of the first embodiment;

FIG. 5 is a fragmentary sectional view of the first embodiment;

FIG. 6 is a schematic perspective view of the first embodiment;

FIG. 7 is a perspective view of a second embodiment of the electric generator according to the disclosure; and

FIG. 8 is a perspective view of a third embodiment of the electric generator according to the disclosure.

### DETAILED DESCRIPTION

Before the disclosure is described in greater detail, it should be noted that like elements are denoted by the same reference numerals throughout the disclosure.

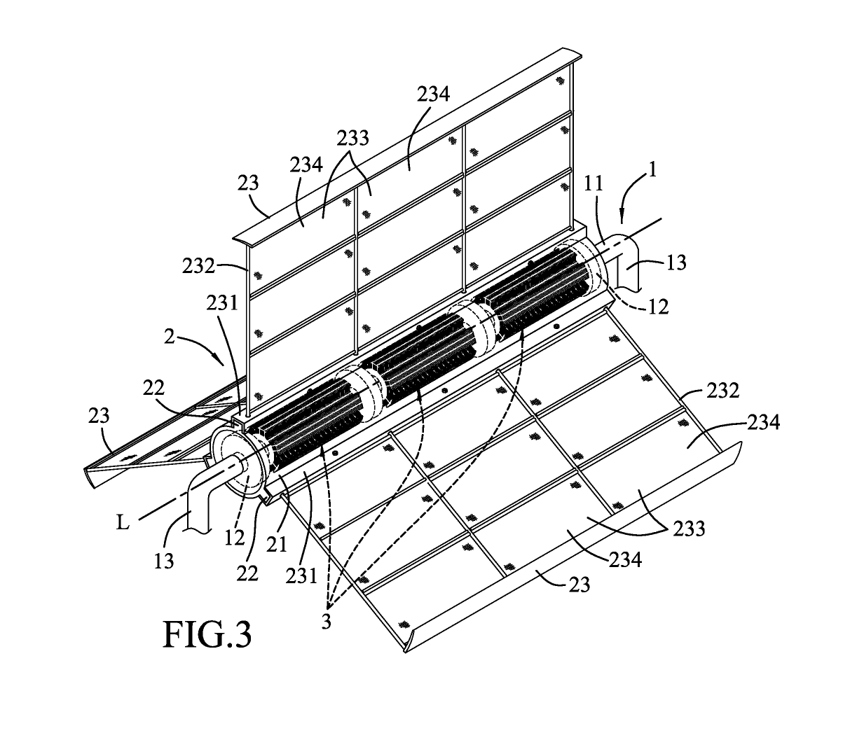

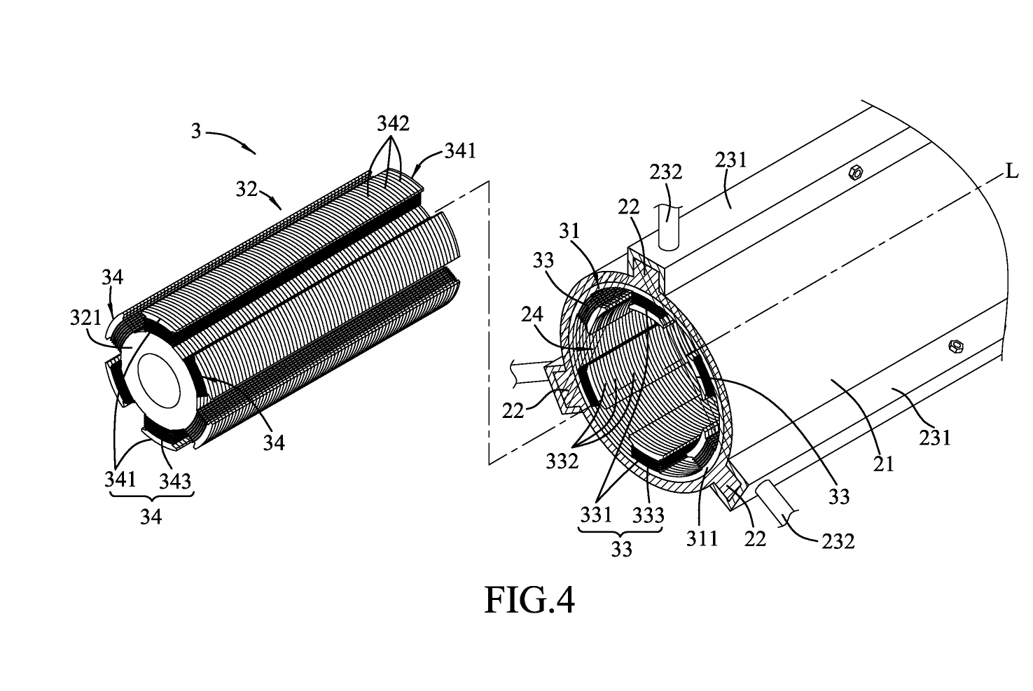

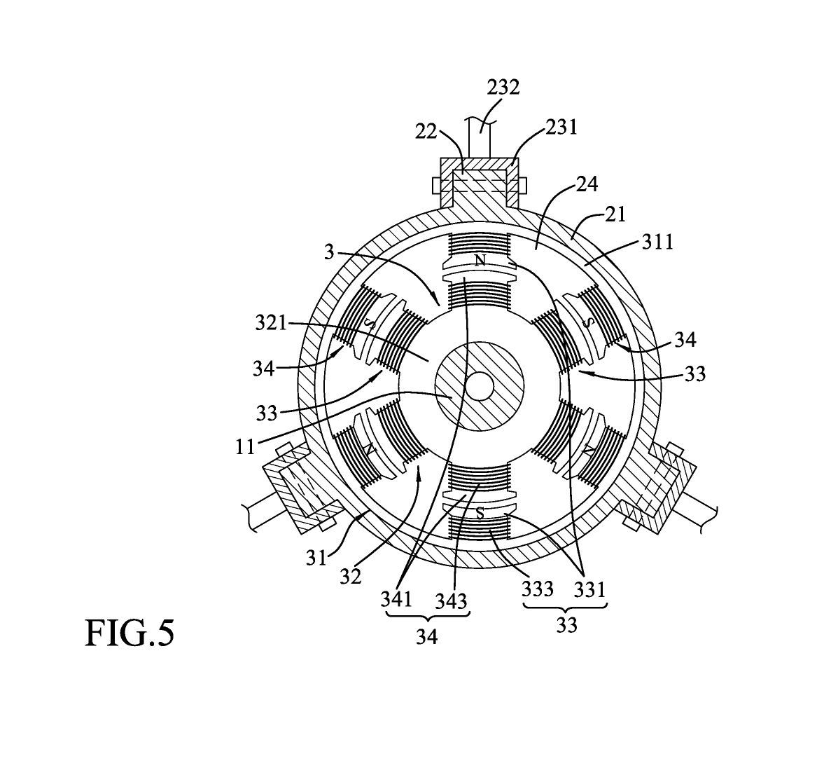

Referring to FIGS. 3 to 5, a first embodiment of the electric generator according to the disclosure includes a base unit 1, a driving unit 2 and a plurality of power generating units 3.

The base unit 1 includes a shaft 11 that extends along a horizontal axis (L), and a plurality of bearings 12 that are mounted on the shaft 11 and that are spaced apart from each other along the horizontal axis (L). The shaft 11 may be hollow or solid, and may be made of metal, glass fiber, reinforced concrete, ceramic or wood. When the shaft 11 is made of metal, an outer surrounding surface of the shaft 11 is preferably to be coated with an insulating layer. The material of the insulating layer is known in the art. In this embodiment, the shaft 11 has opposite longitudinal ends supported respectively by two support stands 13. In a variation, the shaft 11 may be mounted between two spaced-apart buildings, or may be mounted on a rotatable object that is equipped with fluid-guiding plates. Since the shaft 11 extends horizontally, the first embodiment is a horizontal-axis generator.

The driving unit 2 includes a tubular member 21 that extends along the horizontal axis (L) and that surrounds the shaft 11, a plurality of angularly spaced-apart mounting seats 22 that are connected integrally to an outer surrounding surface of the tubular member 21, and a plurality of blade modules 23 that are mounted respectively to the mounting seats 22 and that project radially and outwardly. The tubular member 21 may be made of aluminum, iron, glass fiber, carbon fiber or other polymers. When the tubular member 21 is made of metal, an inner surrounding surface of the tubular member 21 is preferably to be coated with an insulating layer. The material of the insulating layer is known in the art. The tubular member 21 is mounted on the bearings 12 so as to be rotatable relative to the shaft 11, and cooperates with the shaft 11 to define a power-generating space 24 therebetween. Each of the mounting seats 22 extends in the longitudinal direction of the tubular member 21.

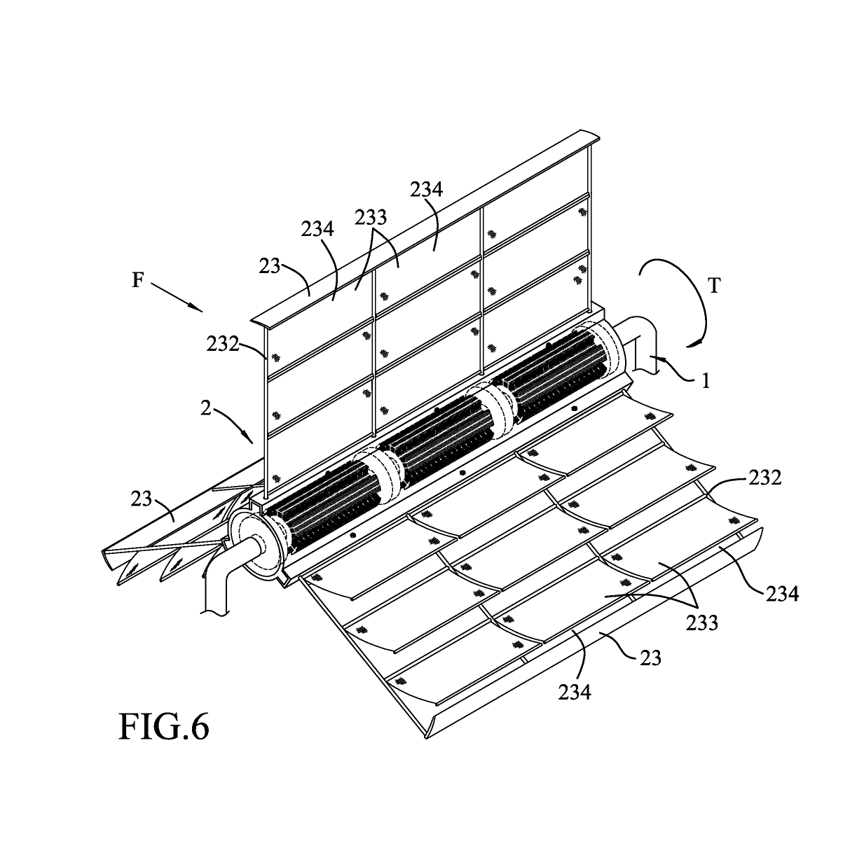

Each of the blade modules 23 is secured to the corresponding one of the mounting seats 22 by screws, and extends in the longitudinal direction of the tubular member 21. Each of the blade modules 23 includes a connecting member 231 that is secured to the corresponding one of the mounting seats 22, a grid frame 232 that is connected to the connecting member 231 and that defines a plurality of ventilation spaces 234, and a plurality of vanes 233 each of which is connected pivotally to the grid frame 232, and pivotable relative to the grid frame 232 between a sealing position (see FIG. 3) where the vane 233 seals a respective one of the ventilation spaces 234, and a non-sealing position (see FIG. 6) where the vane 233 is rotated relative to the grid frame 232 to open the corresponding one of the ventilation spaces 234. For each of the blade modules 23, each of the vanes 233 is only permitted to pivot in the same direction to open the corresponding one of the ventilation spaces 234. Referring to FIG. 6, when a fluid flow (F) drives rotation of the driving unit 2 in a rotational direction (T), the vanes 233 of the corresponding blade modules 23 (the lower two blade modules 23 in FIG. 6) that move in a direction counter to that of the fluid flow (F) are moved to the non-sealing position so as to diminish the drag force applied on the blade module 23.

The power generating units 3 are disposed in the power-generating space 24, and are arranged along the horizontal axis (L). Each of the power generating units 3 includes a stator 32 that is connected fixedly to the outer surrounding surface of the shaft 11, and a rotor 31 that is connected co-rotatably to the inner surrounding surface of the tubular member 21 such that the rotor 31 is rotatable relative to the stator 32. For the sake of brevity, only one power generating unit 3 will be illustrated in the following paragraphs.

The rotor 31 includes an outer tubular seat 311 that is disposed on the inner surrounding surface of the tubular member 21, and three angularly and equidistantly spaced-apart magnetic pole pairs 33 that are disposed on the outer tubular seat 311. Each of the magnetic pole pairs 33 includes two magnetic core seats 331 that are disposed on an inner surrounding surface of the outer tubular seat 311 and that are diametrically opposite to each other, and a field coil 333 that is wound around the magnetic core seats 331 for producing a magnetic field. The outer tubular seat 311 and the magnetic core seats 331 of the magnetic pole pairs 33 are formed from a plurality of identical first magnetic conductive sheets 332 that are stacked along the horizontal axis (L) and that are made of magnetic conductive material. In another variation of the first embodiment, the outer tubular seat 311 and the magnetic core seats 331 of the magnetic pole pairs 33 (i.e., the first magnetic conductive sheets 332) may be formed as one piece. In the first embodiment, the presence of the outer tubular seat 311 facilitates the assembling process of the rotor 31 and the tubular member 21. In another variation, the outer tubular seat 311 may be omitted, and the magnetic core seats 331 of the magnetic pole pairs 33 may be provided on the inner surrounding surface of the tubular member 21. The field coils 333 of the magnetic pole pairs 33 may be separately excited, series excited, shunt excited or compound. Each of the magnetic pole pairs 33 may be configured as a pair of permanent magnets.

The stator 32 includes an inner tubular seat 321 that is disposed on the outer surrounding surface of the shaft 11, and three angularly and equidistantly spaced-apart armature winding units 34 that are disposed on the inner tubular seat 321. Each of the armature winding units 34 includes two armature core seats 341 that are disposed on an outer surrounding surface of the inner tubular seat 321 and that are diametrically opposite to each other, and an armature coil 343 that is wound around the armature core seats 341. The inner tubular seat 321 and the armature core seats 341 of the armature winding units 34 are formed from a plurality of identical second magnetic conductive sheets 342 that are stacked along the horizontal axis (L) and that are made of magnetic conductive material. In another variation of the first embodiment, the inner tubular seat 321 and the armature core seats 341 of the armature winding units 34 (i.e., the second magnetic conductive sheets 342) may be formed as one piece. In the first embodiment, the presence of the inner tubular seat 321 facilitates the assembling process of the stator 32 and the shaft 11. In another variation, the inner tubular seat 321 may be omitted, and the armature core seats 341 of the armature winding units 34 may be provided on the outer surrounding surface of the shaft 11. The armature coils 343 of the armature winding units 34 may be Y-connected or delta-connected, and may be connected electrically to a rectifier (not shown) for converting the output alternating current to a direct current.

The first embodiment of this disclosure includes three magnetic pole pairs 33 and three armature winding units 34, so that the first embodiment is configured as a three-phase six-pole electric generator. In another variation, the number of the magnetic pole pairs 33 and the armature winding units 34 may be changed depending on different demands.

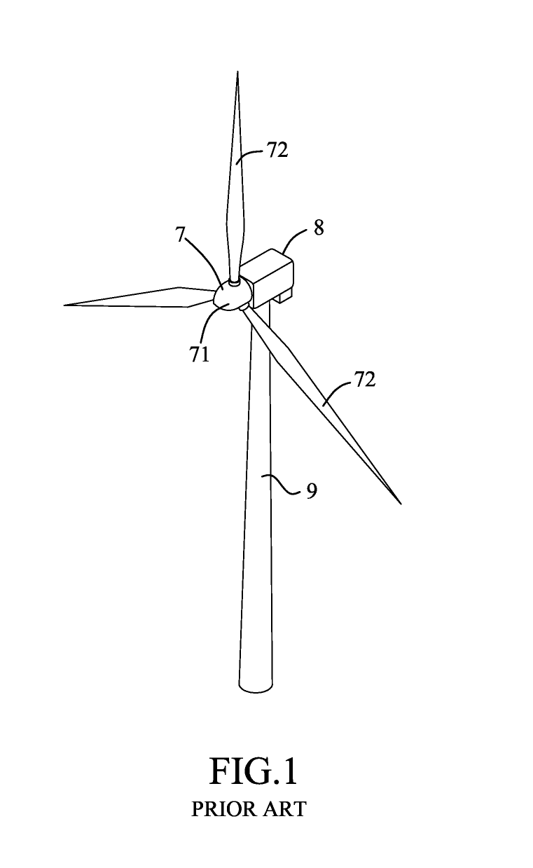

When an external force generated by wind, tide or ocean current propels the blade modules 23 to drive rotation of the driving unit 2 relative to the base unit 1, the rotor 31 is rotated relative the stator 32 to induce a current. Since the blade modules 23 are configured to be mounted on the outer surrounding surface of the tubular member 21, each of the mounting seats 22 can extend over the whole outer surrounding surface of the tubular member 21 for being mounted with a corresponding one of the blade modules 23. Compared with the conventional horizontal-axis wind turbine in FIG. 1, the driving unit 2 has relatively superior structural strength.

It should be noted that, in this embodiment, the length of the power-generating space 24 in the direction of the horizontal axis (L) is nearly the same as the whole length of the electric generator, so that the power-generating space 24 is relatively large compared with the conventional horizontal-axis wind turbine. As a result, the number of turns of the armature coils 343 and the field coils 333 of the power generating units 3 can be greater, and the current induced by the power generating units 3 is relatively great.

It should be further noted that, in another variation of the first embodiment, the stator 32 is configured to include the magnetic pole pairs 33, and the rotor 31 is configured to include the armature winding units 34. The current induced in the armature winding units 34 is output by means of a plurality of ring members (not shown).

The first embodiment may be equipped with a constant frequency device or a variable frequency device to stabilize the induced current when the external force is generated by an unstable wind.

To sum up, since each of the mounting seats 22 can extend over the whole outer surrounding surface of the tubular member 21 for being mounted with a corresponding one of the blade modules 23, the driving unit 2 has relatively superior structural strength. Moreover, since the length of the power-generating space 24 in the direction of the horizontal axis (L) is nearly the same as the whole length of the electric generator, the number of turns of the armature coils 343 and the field coils 333 of the power generating units 3 can be greater, and the current induced by the power generating units 3 is also greater.

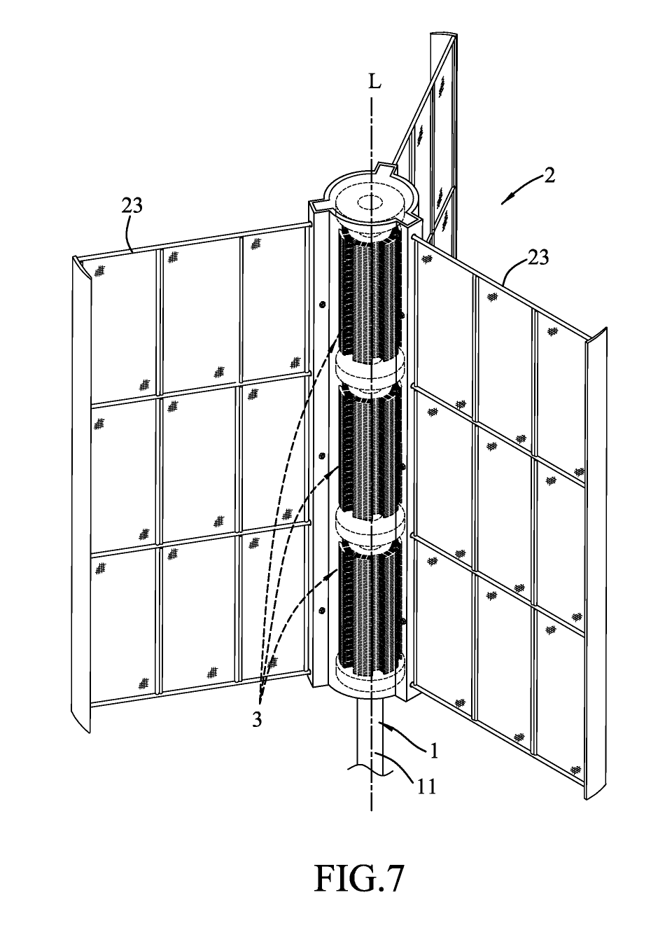

Referring to FIG. 7, a second embodiment of the electric generator according to the disclosure is similar to the first embodiment. What is different is that the shaft 11, the tubular member 21 and the blade modules 23 extend along a vertical axis (A), such that the second embodiment is a vertical-axis generator. Note that the shaft 11 of the second embodiment may be configured as the vertical rod portion of an electric pole or a street light, a column of a building, or a tree trunk. Since the vertical-axis generator can be driven by a wind that blows in an arbitrary direction, the second embodiment is suitable for aerial or ground use.

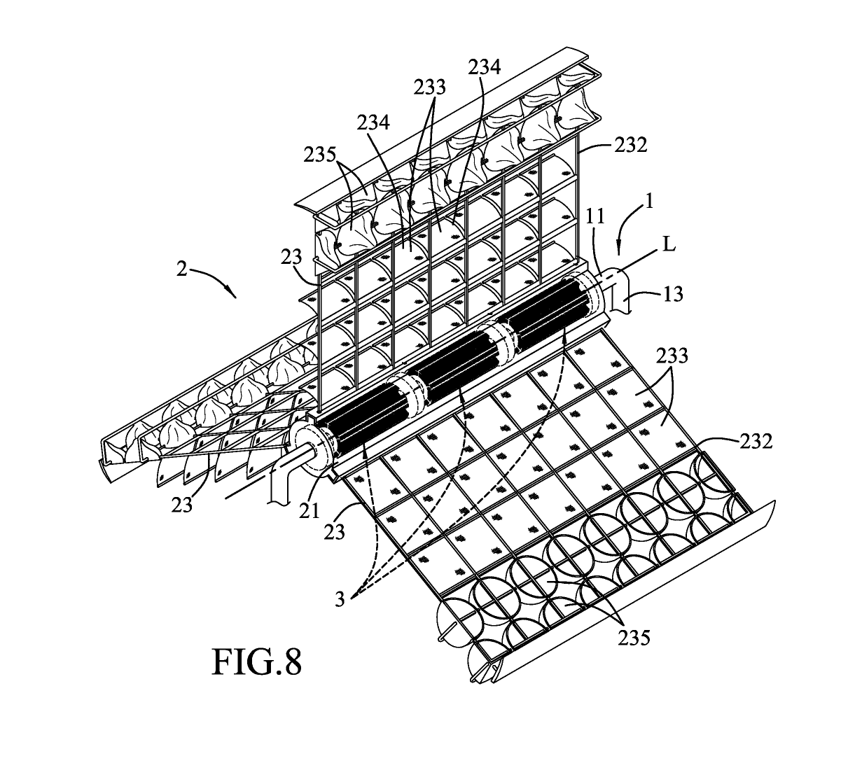

Referring to FIG. 8, a third embodiment of the electric generator according to the disclosure is similar to the first embodiment. The grid frame 232 of each of the blade modules 23 has an extension portion that extends radially and outwardly and that is mounted with a plurality of cup members 235.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An electric generator comprising:
a base unit including a shaft;
a driving unit including a tubular member that surrounds said shaft and that is rotatable about said shaft, and a plurality of blade modules that are disposed co-rotatably on said tubular member; and
at least one power generating unit including a stator that is connected fixedly to said shaft, and a rotor that is connected co-rotatably to said tubular member, said rotor being rotated relative to said stator to induce a current when said blade modules are driven by a fluid flow to rotate said tubular member relative to said shaft.

2. The electric generator as claimed in claim 1, wherein said stator includes at least one armature winding unit that is connected fixedly to said shaft, said rotor including at least one magnetic pole pair that is connected co-rotatably to an inner surrounding surface of said tubular member, said armature winding unit outputting an induced current when said magnetic pole pair is rotated relative to said armature winding unit.

3. The electric generator as claimed in claim 2, wherein said armature winding unit includes two armature core seats, and an armature coil that is wound around said armature core seats, said magnetic pole pair including two magnetic core seats, and a field coil that is wound around said magnetic core seats.

4. The electric generator as claimed in claim 3, wherein said magnetic core seats of said magnetic pole pair are formed from a plurality of first magnetic conductive sheets that are stacked in an extending direction of said shaft, said armature core seats of said armature winding unit being formed from a plurality of second magnetic conductive sheets that are stacked in the extending direction of said shaft.

5. The electric generator as claimed in claim 2, wherein said stator includes three of said magnetic pole pairs that are angularly and equidistantly spaced apart from each other about said shaft, said rotor including three of said armature winding units that that are angularly and equidistantly spaced apart from each other about said shaft, said armature winding units outputting the induced current when said rotor is rotated relative to said stator.

6. The electric generator as claimed in claim 1, wherein said stator includes at least one magnetic pole pair that is connected fixedly to said shaft, said rotor including at least one armature winding unit that is connected co-rotatably to an inner surrounding surface of said tubular member, said armature winding unit outputting an induced current when said armature winding unit is rotated relative to said magnetic pole pair.

7. The electric generator as claimed in claim 6, wherein said armature winding unit includes two armature core seats, and an armature coil that is wound around said armature core seats, said magnetic pole pair including two magnetic core seats, and a field coil that is wound around said magnetic core seats.

8. The electric generator as claimed in claim 7, wherein said magnetic core seats of said magnetic pole pair are formed from a plurality of first magnetic conductive sheets that are stacked in an extending direction of said shaft, said armature core seats of said armature winding unit being formed from a plurality of second magnetic conductive sheets that are stacked in the extending direction of said shaft.

9. The electric generator as claimed in claim 6, wherein said stator includes three of said magnetic pole pairs that are angularly and equidistantly spaced apart from each other about said shaft, said rotor including three of said armature winding units that that are angularly and equidistantly spaced apart from each other about said shaft, said armature winding units outputting the induced current when said rotor is rotated relative to said stator.

10. The electric generator as claimed in claim 1, wherein said shaft extends horizontally, said tubular member extending horizontally.

11. The electric generator as claimed in claim 1, wherein said shaft extends vertically, said tubular member extending vertically.

12. The electric generator as claimed in claim 1, wherein said driving unit further includes a plurality of angularly spaced-apart mounting seats that are disposed on an outer surrounding surface of said tubular member and that extend radially and outwardly for being mounted respectively with said blade modules.
